(19) United States
(12) Patent Application Publication
(10) Pub. No.: US 2008/0208580 A1
(43) Pub. Date: Aug. 28, 2008

(54) Method and Dialog System for User Authentication

(75) Inventor: Holger Scholl, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,711

(22) PCT Filed: May 25, 2005
(86) PCT No.: PCT/IB05/51701

§ 371 Date: Nov. 28, 2006

(30) Foreign Application Priority Data
Jun. 4, 2004 (EP) 04102514.9

(51) Int. Cl. G10L 17/00

(52) U.S. Cl. 704/246; 704/E17.001

(57) ABSTRACT

The invention relates to a method of authenticating a user (N). In a dialog between the user (N) to be authenticated and a dialog system (1; D), a plurality of security queries is performed by the dialog system (1; D). A security query is taken from one of a plurality of predetermined categories of questions and/or corresponds to one of a plurality of predetermined types of questions. The user (N) supplies answers to the security queries in the form of speech to the dialog system (1; D) and the user's (N) answers are evaluated. A user (N) is authenticated or not authenticated in dependence upon the result of the evaluation.

The invention relates to a method of user authentication and a corresponding, particularly computer-supported dialog system for user authentication.

In the last few years, rapid technological developments in the field of digital electronics have led to an increasing use of computer-supported methods in more and more areas of life. Computer-supported processes have become indispensable in, for example, areas of service. Nowadays, it is possible to draw money from a computer-supported cashpoint, pay for products at the supermarket by using an EFT (electronic fund transfer) terminal, or buy tickets from a ticket machine while using a cashpoint card. Similarly, computer-supported access systems have been established, which allow one or more users access to a closed area of security or to particularly secured information.

All of these methods are based on user authentication, i.e. particularly on checking the identity or “genuineness” of the user. The authentication is regularly based on a computer-supported dialog between the user to be authenticated and a dialog system. A plurality of dialog processes is known in this case. A dialog process usually starts with a user identification query. The user identification may consist of, for example, a log-in name, a bank account number, the user's name or an identification stored on a chip card. This identification is often known to a comparatively large circle of persons and their input into the dialog system is often unconcealed. In a second step, the dialog system asks information by means of a security query to the user, which information corresponds to the inputted user identification and is known only to the user or a given authorized circle of persons. This information is often constituted by a password or a secret number (PIN) which is entered in a concealed manner by the user.

The dialog process described above between the dialog system and the user to be authenticated may be completely or partially based on the input or output of acoustical or optical information. Recently, dialog systems have become established which have a display inviting the user to enter his user ID or insert his user card into the dialog system. By means of a keyboard, the user enters his ID or inserts his user card into the dialog system. After processing the supplied user ID or the identification read from the user card, the user is invited again via the display to enter his PIN number. After entry of the PIN number by means of the keyboard, the dialog system checks whether the entered PIN number matches the supplied user ID or the identification that has been read. For this purpose, a pair of user identification and PIN number is stored for each user in the dialog system. When the entered PIN number matches the entered user ID or the identification that has been read, i.e. when the entered PIN number and the entered user ID or the identification that has been read are stored as a pair in the dialog system, then the user is considered to be authenticated and is thus authorized to have access to given information, use given services or obtain given products or valuables.

The known authentication methods mainly have the drawback that the operation of corresponding dialog systems is not particularly user-friendly. The reason is that the entry of a user ID by means of a keyboard or the insertion of a user card into a dialog system and the entry of a PIN number by means of a keyboard is time-consuming, particularly in the business area. For example, payment by means of a credit card at the checkout in a supermarket delays the process to a considerable extent.

To implement authentication methods in a more comfortable way, many proposals have already been made to use biometrical features such as a user's voice, his iris, facial shape or finger print for authentication. Up to now, biometrical authentication methods have not gained ground because the realization of such systems requires great technical effort and financial costs, and the avoidance of erroneous authentications cannot be safely guaranteed.

It is therefore an object of the invention to provide a method and a dialog system for user authentication, allowing a user-friendly and secure user authentication.

This object is solved by means of a method as defined in claim 1 and a dialog system as defined in claim 14. Advantageous further embodiments of the invention are defined in the dependent claims. Further developments of the system claim corresponding to the dependent claims of the method claim are also within the scope of the invention.

According to the invention, the method of user authentication is thus based on a dialog between the user to be authenticated and a dialog system. In the dialog, a plurality of security queries is supplied by the dialog system. A security query is taken from one of a plurality of predetermined categories of questions and/or corresponds to one of a plurality of predetermined types of questions. The answers to the security queries, given by the user in the form of speech, are evaluated by the dialog system in dependence upon the relevant category of questions and/or the relevant type of questions of the question concerned and, in dependence upon the result of the evaluation, the user is classified as “authenticated user” or “unauthenticated user”.

By supplying answers to the security queries in the form of speech by the user, it is possible to implement the authentication method for the user in a comfortable way. The use of a keyboard is no longer or at least minimally required for entering the answers. When the authentication method completely refrains from the use of a keyboard, the dialog system can be realized without a keyboard and thus at less cost.

If only conventional dialog systems for authentication were combined with a speech recognition device so as to allow entry of answers to security queries by means of speech, there would be only one security query which would then of course also determine the sole category of questions and the sole type of questions. This security query would be: “What is your PIN number?”. However, such an authentication method would not be secure because an unauthorized third party could then easily intercept the user's PIN number at a cashpoint and use it for unauthorized access at a later stage.

It is achieved by the invention that answers to security queries can be entered in the form of speech by a user, while unauthorized third persons listening to the dialog nevertheless do not obtain sufficient information from this dialog for unauthorized user authentication at a later stage, i.e. the answers are not “revealing”. The method according to the invention is based on the answers to a plurality of security queries which can be taken in a variable manner from a pool of questions categorized in accordance with categories of questions and assorted in accordance with types of questions. This provides the possibility of implementing an authentication method in a secure manner, also when the answers to the security queries are given in the form of speech.

As compared with an authorization method in which security queries are made from only one category or only one type of questions, the security is considerably improved by performing the security queries within an authorization process from different categories or different types of questions.

The security queries are preferably performed in an optical manner, particularly by means of a display or a monitor, or acoustically via, for example, a headphone or an earphone in the user's ear. It is then impossible for an unauthorized third person to assign the intercepted answers to the security query that is not recognizable to him and thus enter the correct answer to a security query in an unauthorized way at a later stage.

The number of security queries may be fixed or randomly selected by the dialog system. The number of required security queries is preferably selected in dependence upon further values such as ambient noise, the required security level or the degree of security or reliability of an additional authentication method such as, for example, the degree of conformity between a stored biometrical sample assigned to the user and a determined biometrical sample.

For example, the probability of the accidentally correct answer to all security queries by an unauthorized person in the case of an output of k independent binary security queries (there are only two possible answers) is 0.5^{k}. When more than two answers to one security query are possible, the risk of unauthorized erroneous authentication can be further reduced accordingly.

One or more of the following categories of questions are preferably used:
a category of questions which is determined in that personal information about the user is queried by means of a question from this category. Examples of personal information are the user's birth date, the birth date of a user's relative, the user's name, the name of a user's relative, the name of a user's domestic pet, the user's favorite color, etc.
a category of questions which is determined in that information which is only known to the user and the dialog system is queried by means of a question from this category. Examples are a personal identification number or a password, etc.
a category of questions which is determined in that information about the use of the dialog system is queried by means of a question from this category. Examples are information about when and/or why the user used the dialog system for the last time.

One or more of the following types of questions are preferably used:
a type of question which is determined in that “yes” is expected as an answer to a question of this type. Questions of this type are thus considered to be correct when “yes” is given as an answer. Examples of such questions are “Your favorite color is yellow, isn't it?”, “Your most recent access to the dialog system was yesterday, wasn't it?”.
a type of question which is determined in that “no” is expected as an answer to a question of this type. Examples of such questions are “Your mother's name is also Sunny, isn't it?” (mother is also called Sally), “Your most recent access to the dialog system was yesterday, wasn't it?” (most recent access was the day before yesterday), “Your birthday is in October, isn't it?” (birthday is in June).
a type of question which is determined in that a one-digit number is expected as an answer to a question of this type. Examples of such questions are “What is the third digit of your personal identification number?”, “What is the second digit of your postal code number?”.
a type of question which is determined in that the question probes whether the dialog system knows or does not know given information. An example of such a question is “Does the dialog system know your favorite question?”.

The authentication method is not only based on answering security queries but also on voice authentication. To this end, a degree of conformity between the user's voice and a voice sample stored in the dialog system is determined. In dependence upon the degree of conformity, the user is classified as either an authenticated or an unauthenticated user. Dependent on the implementation of the invention in accordance with an arbitrarily predetermined weighting, the result of the authentication may depend on the answers to the security queries and on the degree of conformity. The reliability of the authentication result is thereby further increased.

Ambient noise may also influence the authentication result. In fact, the louder the ambient noise, the more unreliable the authentication based on the answers to the security queries and the authentication based on the user's voice.

The answers to the security queries are interpreted or evaluated by means of a speech recognition method. The determined degree of speech recognition (degree of confidence) can thus be preferably included in the authentication result. In fact, the lower the degree of speech recognition, the more unreliable the authentication based on the answers to the security queries.

The system preferably expects a false answer by the user to given security queries, in which the query of false answers follows a rule which is known to the user. Since only the authorized user knows which questions are to be deliberately answered falsely, it will even be more difficult for an unauthorized third person to intercept information so as to authenticate himself as a user in an unauthorized way at a later stage. At the positions where a false answer to a security query is expected, the dialog system can preferably perform security queries that can be very easily guessed by unauthorized third persons, even when they cannot see or hear the questions themselves, so that unauthorized listeners can be misled.

In a particularly preferred embodiment, the plurality of security queries is outputted as a sequence, interrupted by the relevant answers, with a false answer being expected to predetermined security queries defined by their position within the sequence. For example, a bit sequence of the length n may be superimposed on a sequence of n security queries. The bit sequence is only known to the dialog system and the authorized user. The bit sequence determines at which positions the dialog system expects the user to give a correct or false answer. This knowledge is then included in the result of the authentication. For example, when three security queries are performed, which are superimposed by the bit sequence 1-0-1, the user knows that the dialog system expects a false answer to the second security query, i.e. the user is then considered to be authenticated when he gives a correct answer to the first and the third security query and a false answer to the second security query. Such a bit sequence to be kept secret, similar to a PIN number, can be assigned to the user. No further rules are then required when the dialog system expects a correct answer and when it expects a false answer.

Alternatively, security queries from one or more predefined categories of questions or a given type of question—only known to the user and the dialog system—have to be answered falsely so as to authenticate the user.

Furthermore, simple code words instead of “yes/no”-answers may be used for additional security, which code words are only known to the user and the system, such as, for example, the word “violet” instead of “yes” and the word “red” instead of “no”. To this end, it is preferred to select those code words which are more easily and more safely comprehensible for a speech-processing system than the words “yes” and “no”. These code words can be changed from time to time, for example, in regular time intervals or after each use of the system.

Fundamentally, arbitrary combinations of different rules or modes may also be used.

The invention also relates to a dialog system for user authentication, comprising an output unit for outputting a plurality of security queries, wherein a security query is taken from one of a plurality of predetermined categories of questions and/or a security query corresponds to one of a plurality of predetermined types of questions, and an input unit for inputting answers spoken by the user. A speech recognition unit interprets the supplied answers. An evaluation device is adapted to evaluate the user's interpreted answers and authenticate or not authenticate the user in dependence upon the result of the evaluation.

These and other aspects of the invention are apparent from and will be elucidated with reference to the embodiments described hereinafter.

In the drawings:

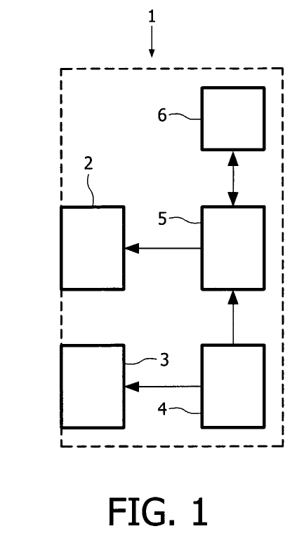

FIG. 1 is a principal circuit diagram of a dialog system;

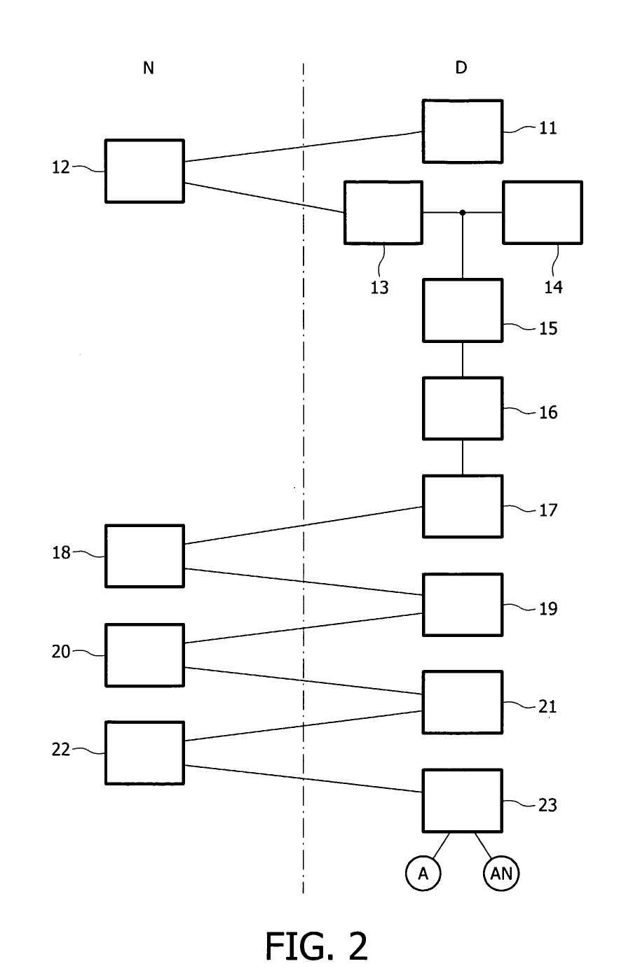

FIG. 2 is a flow chart of a dialog for authentication.

FIG. 1 shows a dialog system 1 for conducting an authentication dialog with a user. The dialog system may be integrated, for example, in a cashpoint, a personal computer, a mobile telephone, a door/door opener or a supermarket cash register, or it may be connected to these apparatuses.

The dialog system 1 has an output device 2 such as, for example, a display and/or an earphone or a loudspeaker through which security queries and operating instructions are given.

Responding to the outputs of the output device 2, a user enters information into the dialog system 1 via an input device 3 such as, for example, a microphone.

When the information to be given by the user is inputted in the form of speech, the information input is interpreted by a speech recognition device 4 arranged subsequent to the input device 3.

Together with a degree of speech recognition, the recognized words are passed on to a control device 5. In this example, the control device 5 comprises an evaluation device for evaluating the words recognized by the speech recognition device. For example, the recognized words are checked on whether they match the user identification that has already been determined. To this end, the control device 5 may access a storage device 6 in which the user identification of all users known to the dialog system 1 and the secret or personal information assigned to the user such as, for example, passwords, PIN numbers, favorite color or birth date, etc. as well as the associated security queries are stored.

The control device 5 may be, for example, completely or partially realized by a program-technically appropriate processor. The control device 5 is not only used for evaluating the recognized user inputs but also for controlling the essential units of the dialog system 1 and thus also for controlling the dialog process. It particularly also controls the security query output.

The dialog system 1 of course also includes all further components conventionally comprised in such a computer-supported dialog system such as, for example, a housing, a power supply unit, cables and data lines, etc.

FIG. 2 shows, by way of example, a dialog process between a user N (left-hand side) and a dialog system D (right-hand side) as described above for authenticating the user N.

The interface between the user N and the dialog system D is constituted by the input device and output device described above. In this example, the dialog system D is to output security queries and operating instructions optically by means of a display and the user is to enter his user inputs in the form of speech via a microphone. However, it will be evident that the invention is not limited to these types of communication. For example, the outputs by the dialog system may alternatively or additionally also be realized by an acoustic output in the form of synthesized speech. The user input may additionally also be realized by means of a keyboard. It is also possible to start the dialog, for example, by means of a user card with a PIN number, which the user N inserts into an appropriate card reading device of the dialog system 1.

The method shown in FIG. 2 is automatically started as soon as a motion sensor signalizes to the dialog system D that there is a user N in its vicinity. The dialog system D thereupon gives the operating instruction “Please state your user name” via the display in step 11 of the method.

The user N subsequently states the user name “user” in step 12. In step 13, the supplied speech sequence is interpreted by means of the speech recognition method, and the name “user” corresponding to a degree of speech recognition that has also been determined is recognized. The name “user” is passed on as user identification to the control device. In addition, the determined degree of speech recognition is passed on to the control device.

As a side product of speech recognition, the speech recognition device determines the voice sample of the speech sequence input in step 14 and also passes it on to the control device.

In step 15, the degree of speech recognition is compared with a predetermined speech recognition threshold value. When the degree of speech recognition is below the speech recognition threshold value, the method is terminated and restarted in step 11. The user could not be determined with sufficient reliability.

In step 16, it is checked to what degree the voice sample stored in the storage device and assigned to the determined user identification conforms to the determined voice sample. When the degree of conformity is below a predefined threshold value of conformity, the process is terminated and restarted in step 11. The voice of the speech sequence input was too different from the voice of the user determined by means of the user name.

In dependence upon the degree of conformity, the number of security queries to be answered by the user is determined. The higher the degree of conformity, the lower the number of security queries.

In the present case, the degree of conformity has been so high that the output of three security queries is required for an adequately secure authentication.

In step 17, the first security query is performed. It is taken accidentally or in accordance with a predefined sample from one of the three following categories:
questions by which personal information about the user N is queried;
questions by which information is queried which is only known to the user N and the dialog system D;
questions by which the information about the use of the dialog system D is queried.

Additionally, the question corresponds to one of the three following types:
questions to which a one-digit number is expected as an answer;
questions to which “yes” is expected as an answer;
questions to which “no” is expected as an answer.

In this example, personal information about the user N is to be queried by means of the first security query and “yes” is expected as an answer. The question “Your favorite color is yellow, isn't?” is asked as the first security query.
In step 18, the user answers “yes”.
In step 19, the second security query is performed. It is also taken accidentally or in accordance with a predefined sample from one of the three above-mentioned categories and corresponds to one of the three above-mentioned types. In this example, the second security query asks information which is only known to the user N and the dialog system D and to which a one-digit number is expected as an answer. The question “What is the third digit of your PIN number?” is asked as the second security query.
In step 20, the user answers “seven”.
In step 21, the third security query is performed. It also originates from one of the three above-mentioned categories and corresponds to one of the three types of question. For example, personal information about the user N is to be asked again by means of the third security query and “no” is expected as an answer. The question “Your mother's name is Inge, isn't it?” is asked as the third security query.
In step 22, the user answers “no”, because his mother's name is Andrea.

Each answer interpreted by the speech recognition device is given a degree of speech recognition which characterizes the reliability of the recognition and is passed on to the control device. In a preferred variant of the invention, each answer interpreted by the speech recognition device is additionally or alternatively given a degree of conformity which describes the degree of conformity between the voice sample of the speech sequence input and stored voice samples assigned to the user identification.

After the user's last answer, the control device, particularly the evaluation device, determines in step 23 whether the user is authenticated A or not authenticated AN. Dependent on the number of correct answers, the result of the evaluation may depend on the degree of conformity of the voice samples of the speech sequence input with stored voice samples assigned to the user identification and/or the degrees of speech recognition. In this way, a large number of correct answers, high degrees of conformity and high degrees of speech recognition lead to a positive decision of authentication, rather than a small number of correct answers, low degrees of conformity and low degrees of speech recognition. For example, low degrees of conformity or low degrees of speech recognition may of course be compensated by a large number of correct answers.

In the case of a negative authentication result, i.e. when the user is not authenticated, the process is terminated and then it is possible to restart, for example, three times.

In accordance with a preferred variant of the invention, the number of security queries may alternatively be adapted during the dialog process to the result of the evaluation. For example, up to a maximum number of twenty security queries, it is possible to perform security queries until the result of the authentication is positive.

Finally, it is to be noted that the Figures and the description of the systems and methods described only deal with embodiments which can be varied by those skilled in the art without departing from the scope of the invention. For example, in the embodiments described above, the interface between the user and the dialog system is particularly realized by a local display and a local microphone. However, this interface may also be based on a remote data connection such as, for example, an Internet connection in which the user communicates with the dialog system via a display and a microphone on his workplace computer, but in which the dialog system is remote from the user, for example, as a central unit of a communication network.

For the sake of completeness, it is to be noted that the use of the indefinite article “a” or “an” does not exclude a plurality of elements or steps.

1. A method of authenticating a user (N), wherein
a dialog is conducted between the user (N) to be authenticated and a dialog system (1; D),
a plurality of security queries is performed by the dialog system (1; D), in which a security query is taken from one of a plurality of predetermined categories of questions and/or a security query corresponds to one of a plurality of predetermined types of questions,
the user (N) supplies answers to the security queries in the form of speech to the dialog system (1; D),
the user's (N) answers are evaluated, and
the user (N) is authenticated or not authenticated in dependence upon the result of the evaluation.

2. A method as claimed in claim 1, wherein a category of questions is determined in that personal information about the user (N) is queried by means of a question from said category.

3. A method as claimed in claim 1, wherein a category of questions is determined in that information which is only known to the user (N) and the dialog system (1; D) is queried by means of a question from said category.

4. A method as claimed in claim 1, wherein a category of questions is determined in that information about the use of the dialog system (1; D) is queried by means of a question from said category.

5. A method as claimed in claim 1, wherein a type of question is determined in that “yes” is expected as an answer to a question of said type.

6. A method as claimed in claim 1, wherein a type of question is determined in that “no” is expected as an answer to a question of said type.

7. A method as claimed in claim 1, wherein a type of question is determined in that a one-digit number is expected as an answer to a question of said type.

8. A method as claimed in claim 1, wherein a degree of conformity between the user's (N) voice and a voice sample stored in the dialog system (1; D) is determined, and the user (N) is authenticated or not authenticated in dependence upon said degree of conformity.

9. A method as claimed in claim 8, wherein the number of security query outputs is automatically determined in dependence upon said degree of conformity.

10. A method as claimed in claim 1, wherein the user (N) is authenticated or not authenticated in dependence upon a determined ambient noise.

11. A method as claimed in claim 1, wherein an answer to a security query is interpreted by means of a speech recognition method, and the user (N) is authenticated or not authenticated in dependence upon a degree of speech recognition determined by means of said method.

12. A method as claimed in claim 1, wherein a user is expected to give a false answer to given security queries.

13. A method as claimed in claim 12, wherein a sequence of security queries is outputted by the dialog system (1; D), and a false answer is expected to predetermined security queries defined by their position within the sequence.

14. A dialog system (1; D) for authenticating a user (N), comprising
an output unit (2) for outputting a plurality of security queries, wherein a security query is taken from one of a plurality of predetermined categories of questions and/or a security query corresponds to one of a plurality of predetermined types of questions,
an input unit (3) for inputting answers spoken by a user,
a speech recognition unit (4) for interpreting the supplied answers, and
an evaluation device (4) which is adapted to
evaluate the user's (N) interpreted answers, and
authenticate or not authenticate the user (N) in dependence upon the result of the evaluation.
